(19) United States
(12) Patent Application Publication
(10) Pub. No.: US 2009/0187543 A1
(43) Pub. Date: Jul. 23, 2009

(54) Asset management system

(76) Inventor: Michael Samborn, Kawkawlin, MI (US)

Correspondence Address: All Star Realty, 108 N. Henry, Bay City, MI, 48706, US

(21) Appl. No.: 12/321,387

(22) Filed: Jan. 21, 2009

Related U.S. Application Data
(60) Provisional application No. 61/011,939, filed on Jan. 23, 2008.
(60) Provisional application No. 61/062,032, filed on Jan. 23, 2008.

(51) Int. Cl. G06F 17/30; G06F 3/048; G06F 7/06

(52) U.S. Cl. 707/3; 715/810; 707/100; 707/E17.044; 707/E17.014

(57) ABSTRACT

A system and apparatus for managing and updating the status of various assets, including but not limited to real estate properties, is disclosed. The system can be used by and provides differing capabilities for all of property managers, banks, and realtors.

### PRIORITY CLAIM

This application claims priority to U.S. Provisional Application Nos. 61/011,939 and 61/062,032, both of which were filed on Jan. 23, 2008, and the contents are incorporated by reference in their entirety herein.

### FIELD OF THE INVENTION

The present invention relates to a system and apparatus for managing and updating the status of various assets, including but not limited to real estate properties.

### BACKGROUND

Many banks and other institutions find themselves stuck with assets, such as but not limited to real estate assets, that cannot be quickly sold and need to be maintained during the sales process. Within the real estate industry, these assets are known as Real Estate Owned (REO) assets. Another way of phrasing this is real estate owned by the bank. Because banks and mortgage companies do not wish to be in the business of owning real estate, these institutions sometimes employ another business entity to manage the properties for them. Consequently, a mechanism for managing these and other types of assets is desired.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an example overview of the financial, legal, and maintenance relationships of a system;

FIG. 2 depicts example details of the database engine of FIG. 1;

FIG. 3 depicts an example of a logon screen;

FIG. 4 depicts an example main navigation screen;

FIG. 5A depicts an example Properties screen depicting a search inquiry;

FIG. 5B shows additional detailed from the search inquiry of FIG. 5A;

FIG. 5C shows details of an advanced search engine;

FIG. 6 depicts an example Open Tasks screen;

FIG. 7 depicts an example maintenance screen;

FIG. 8 depicts an example Task Templates screen;

FIG. 9 depicts an example Resources screen;

FIG. 10 depicts an example block diagram of a computer system upon which an embodiment of the invention may be implemented;

FIG. 11 depicts an example Billing screen;

FIG. 12A depicts a refined version of the search engine shown in FIG. 5C;

FIG. 12B depicts exemplary search results when clicking on a certain part of the user interface of FIG. 12A;

FIG. 12C depicts status of offers arising from clicking on a certain part of the user interface of FIG. 12B; and

FIG. 13 depicts an exemplary user interface for storing client information.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the following description, an example heading of REO OFFICE MANAGER will frequently be used, both within this specification as well as various of the Figures, where as stated REO stands for Real Estate Owned. However, it is to be noted that this designation is but for example purposes only, so that the present invention should not be considered as limited exclusively thereto. Similarly, many of the assets shown in the following illustrations will be real estate properties. However, the invention discussed herein could be used for many asset management purposes beyond real estate, and again should not be construed as limited exclusively thereto.

When a bank seizes a house in foreclosure, numerous several tasks need to be handled. The lawn needs to be mowed, the snow shoveled. In a winter environment, the pipes may need to be drained and the house winterized (anti-freeze in the pipes, shut off the furnace). Additionally, many states allow for a six-month redemption period in which a house can be re-purchased by the original owner, subject to numerous restrictions. Thus, the bank can initiate foreclosure proceedings, but cannot proceed with actually selling the house until a set period of time expires, such as but not limited to six months. In such a case, the bank is holding a valuable asset worth many thousands of dollars, and has to take care of that asset subsequent to a sale or redemption.

However, as stated, banks do not want to be in the business of maintaining distressed inventory of real properties. These maintenance tasks are numerous, can be complex, and often must be repeated. With a large portfolio of properties, the system 100 makes it easier to track and manage when these tasks have been achieved. In the event an important task is not met that needs attention, the system 100 makes it easier to detect and address such an unmet task.

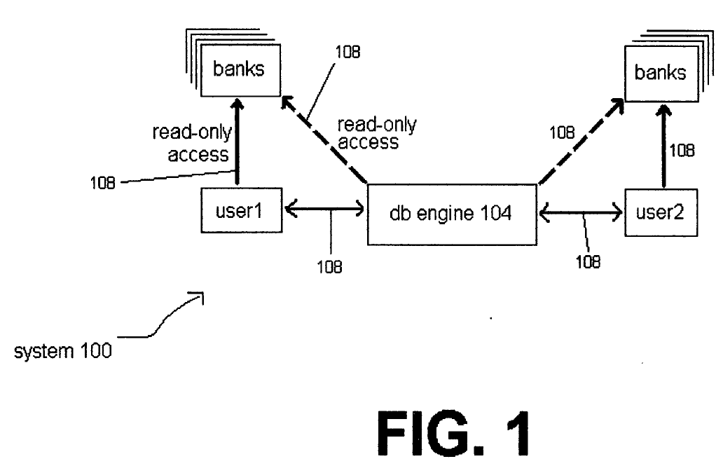

FIG. 1 shows an example overview of the financial, legal, and maintenance relationships of a system 100 for managing assets. From FIG. 1 it is apparent that the system 100 comprises a database engine 104 connected to a plurality of users (e.g. user1 and user2), as well as optionally connected to one or more banks or other types of customers. The connection means 108 can be but is not necessarily a type of Internet connection, such as but not limited to the World Wide Web. Some banks may wish to have direct access to the db engine 104, while other banks may not want this feature. Thus the connection is shown in a dashed format to connote optional. The users of the system 100 could be for example real estate management companies or real estate brokerages who want to track and update information regarding a large volume of real properties or other assets, and do so in a user-friendly web-accessible way. These users may in turn be managing real properties or other assets on behalf of one or more banks, but may also have their own inventory of real properties or assets that require additional management.

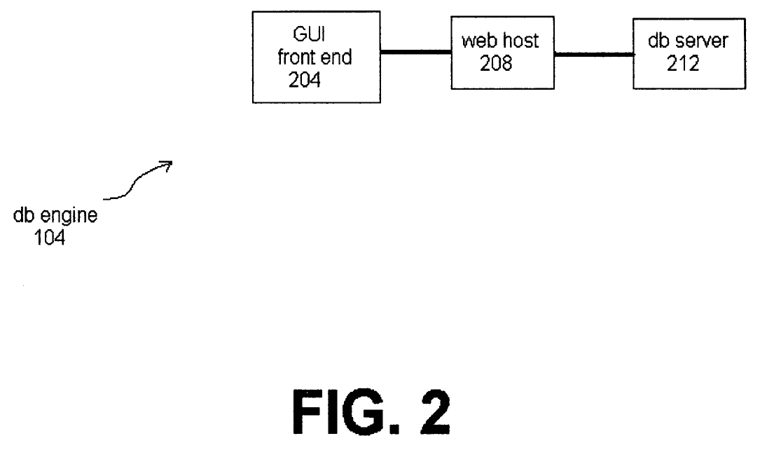

FIG. 2 shows example details of the database engine 104. It is to be noted that the features shown in FIG. 2 are but for example purposes only, so that the db engine 104 or system 100 should not be considered as limited exclusively to that shown in FIG. 2. From FIG. 2 it is apparent that a graphical user interface (GUI) 204 allows access (such as but not limited to Internet access) to a web host 208, which in turn communicates with a back-end database server 212. Only the users and persons with access to the database engine 104 would be able to write to and update data within the database server 212. The banks, to the extent they have access at all, would only have read-only access to the db server 212. The GUI 204 can contain scripts and other mechanisms for filtering data prior to entry (e.g. dates or other numeric fields require all input be numeric-only, all text will be stripped out and the user provided with a warning). The GUI 204 ensures that accessing the different areas of the system 100 can be done in a portable and user-friendly manner. This includes from any location where the Web is accessible, with no front-end software needed.

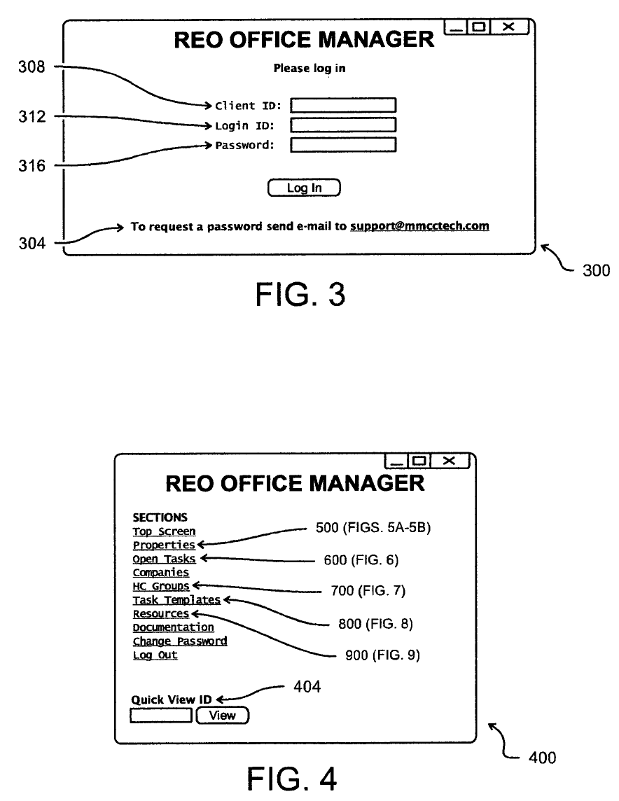

FIG. 3 is an example of a logon screen 304 of the GUI 204 which enables access to the system 100. From FIG. 3 it is apparent that a client ID 308, login ID 312, and password 316 are required to enter the system 100. Referring back to FIG. 1, the users from FIG. 1, or the banks, could conceivably access the system 100 through the logon screen 304. It is important to note however, that a single user or real estate manager may service multiple clients (e.g. banks) through the same front end logon screen 304. Because complex financial data is stored therein, security is paramount. Thus, the back end database server 212 keeps all bank data carefully separated, segregated, and secure. For example, Bank A must be prevented from accidentally viewing the asset inventory of Bank B.

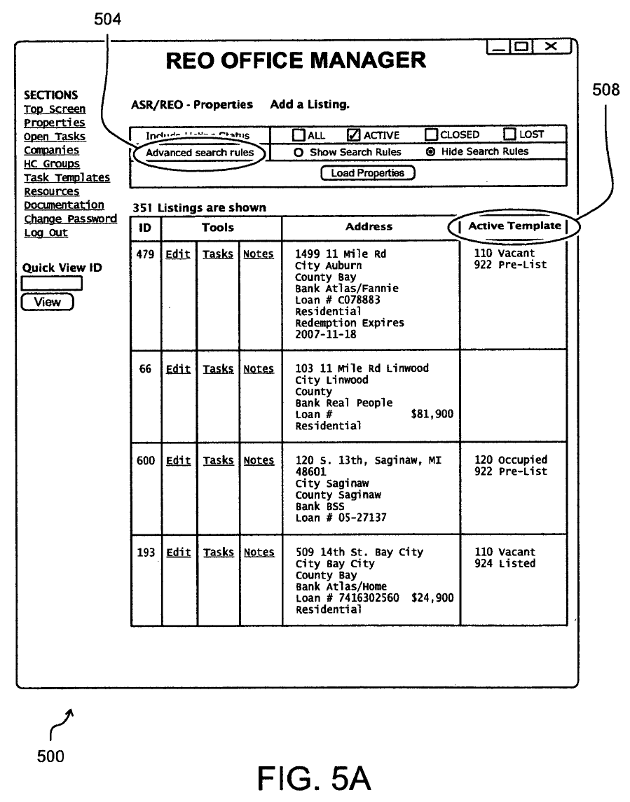

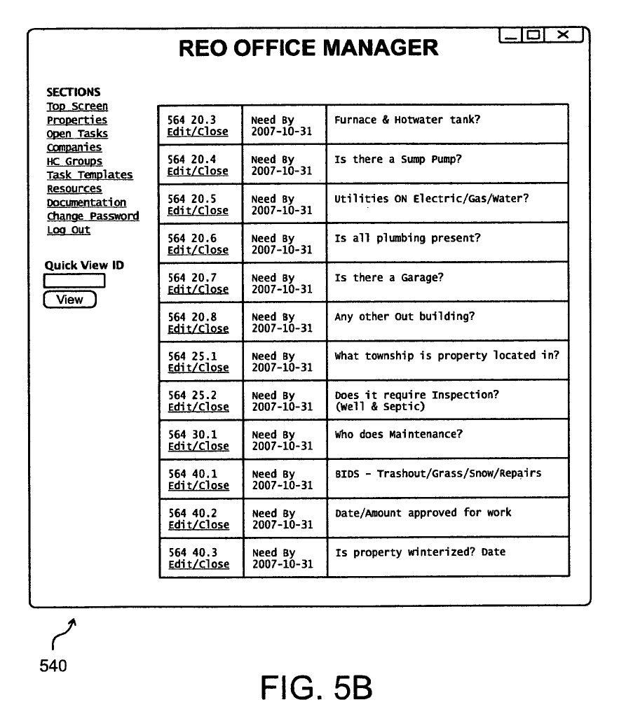

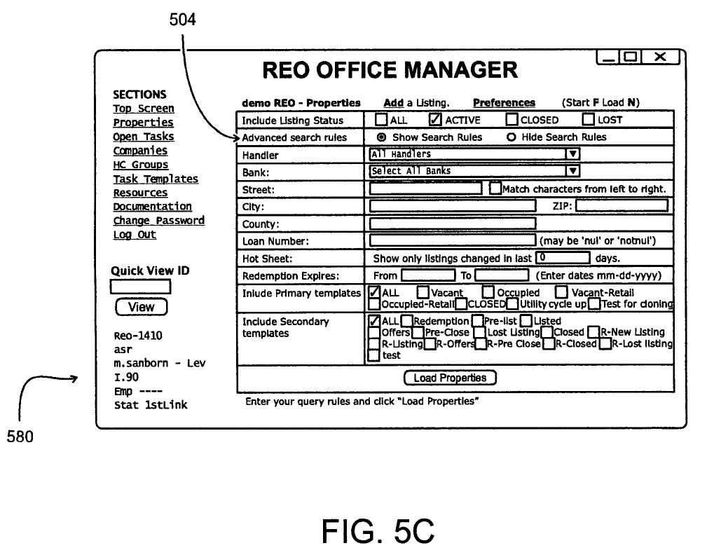

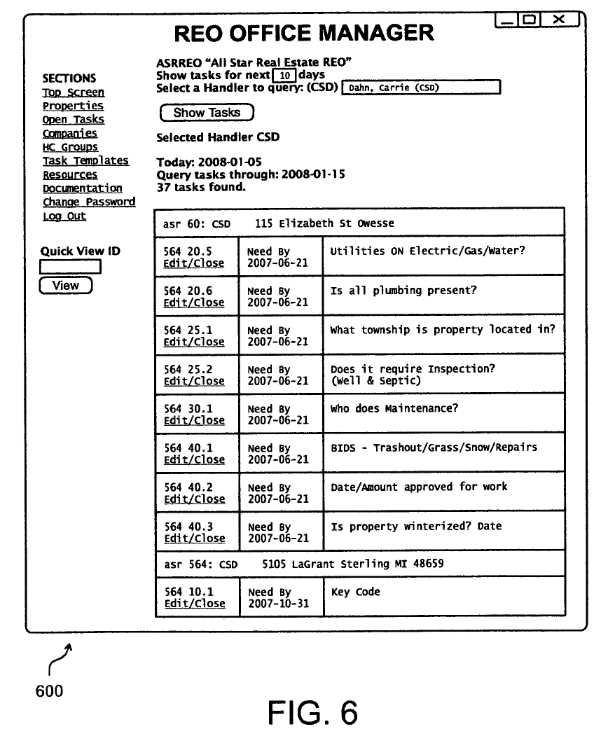

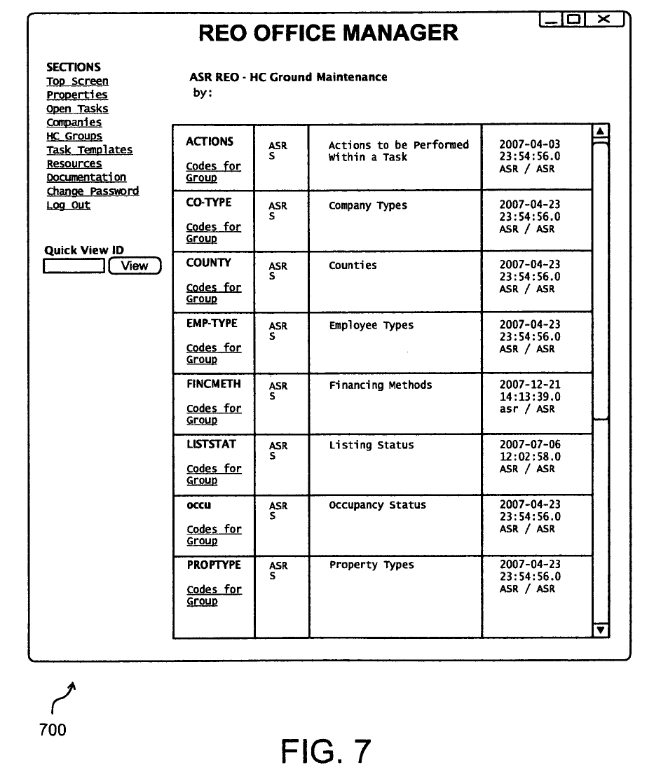

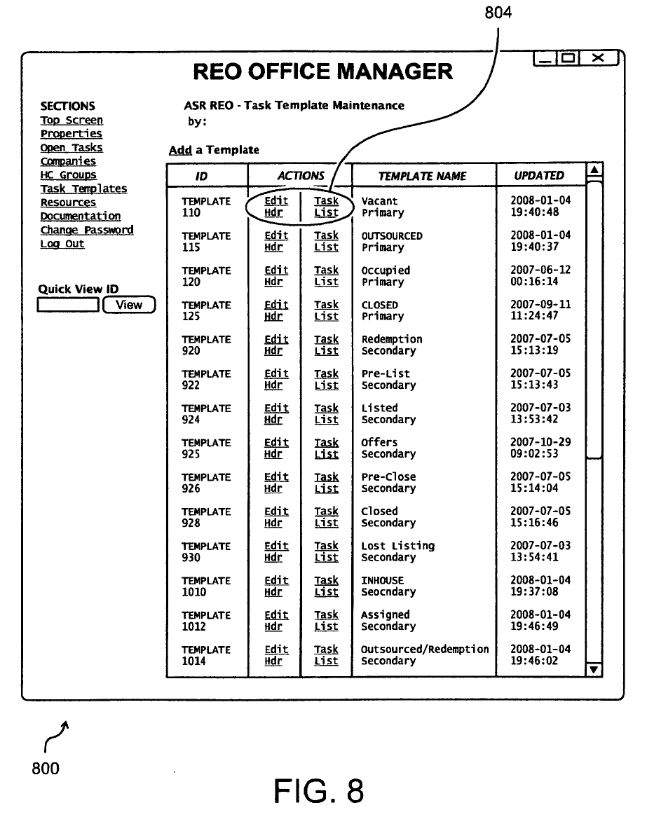

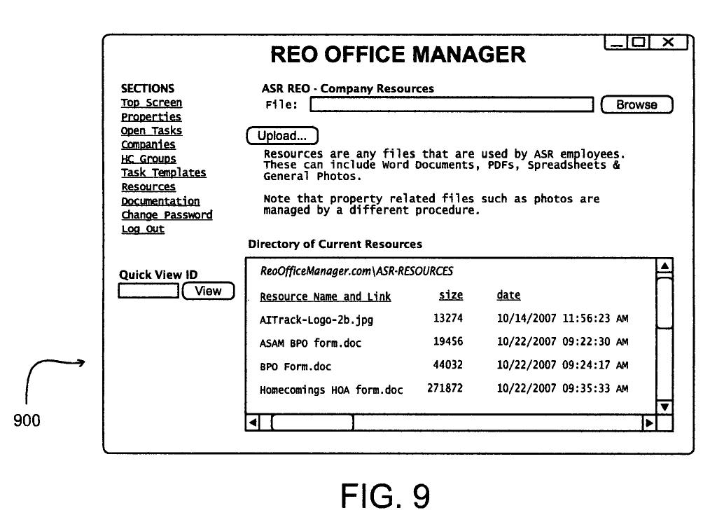

FIG. 4 shows the starting point and main navigation screen 400 when first logging on to the system 100. Several user-selectable options are available within the screen 400, including but not limited to Properties 500 (depicted in more detail in FIGS. 5A, 5B, and 5C); Open Tasks 600 (depicted in more detail in FIG. 6); Companies, HC Groups 700 (depicted in more detail in FIG. 7); Task Templates 800 (depicted in more detail in FIG. 8); Resources 900 (depicted in more detail in FIG. 9); Documentation, Change Password, and Log Out.

The Properties screen 500 allows viewing of all assets (such as real estate properties). A user can request a display of properties by status or use the search screen which permits narrowing to specifics of a search of inventory of assets, such as but not limited to real estate properties.

The search for properties can be at least by city, county, status, address, or client (e.g. bank). These appear in FIG. SA under the “advanced search rules” button 504. The search results of FIG. 5A show that property ID numbers 479, 66, 600, and 193 came up as part of the example search results. The active template 508 indicates that the type of template currently in-use for that particular product. Templates will be discussed in more detail herein, particularly in the discussion of FIG. 8. The active template 508 is but one of numerous means to quickly determine the status of a particular property.

FIG. 5B shows more detailed about a specific search inquiry. The property screen 500 shows a variety of details about a property number 564. The numbers 20.3, 20.4, through 40.3 are examples of system-assigned section and step numbers.

FIG. 5C shows an advanced search interface, where search parameters comprise handler, bank, street, city, county, loan number, hot sheet, primary template, and secondary template. The button “load properties” effectively states “begin the search”. The “show search rules hide search rules” toggle is provided to accommodate users of varying level of sophistication and skill, and also whether those users are familiar with the search interface. The search rules are intended to assist a beginning user. After some length of time, a user will not need the search rules. In the event an advanced user needs a hint on a search rule, they can toggle a button to “show” search parameters rather than “hide” them.

The Open Tasks screen 600 depicts tasks related to tracking the progress of the property from beginning of assignment to closing (e.g. sale) of that property. With any property, whether a bank REO or private listed, there will always be specific client tasks necessary for maintaining the property through the entire real estate life cycle, that is, from first assignment to final close. The Open Tasks screen 600 assists in keeping track of what a user has to do and confirms it has been completed and allows checking on the status periodically or assist in responding to specific inquiries from clients. The system 100 also supports having tasks recycle or reset themselves to remind that it needs to be done if it is a recurring item ex. cut grass every 14 days, or send in monthly report every 30 days.

While in the Open Tasks screen 600, the tasks for a specific file handler (human assistant or employee) can be viewed to see what is pending to be or has been accomplished for a particular file handler internally. A supervisor or administrator can monitor the performance or workload for a particular human assistant, and can redistribute tasks depending on whether that is overloaded, free and available for more work, has just been hired, or has recently been discharged. Thus, the Open Tasks screen 600 can be used for load-balancing of tasks. Within the example Open Tasks screen 600 shown in FIG. 6, the file handler is an employee named Carrie Dahn. The Open Tasks screen 600 lets Carrie know her daily tasks to get completed on her “to do” list. Having such a “to do” list available on the web and viewable by both management and employee eliminates ambiguities over whether an employee is aware they are responsible for a specific task.

As with FIG. 5B, the numbers 20.5, 20.6, through 40.3 are examples of system-assigned section and step numbers.

FIG. 7 shows an HC Groups screen 700, which is a maintenance area (HC=homes/codes) where an administrator (such as the database administrator of a property management company) can setup and customize needed items for different groups and items that are needed when a property is input. The HC Groups screen 700 is only managed by the assigned administrators in the office of a property manager user. HC are the items a client deems that they need in particular groups used for each property. This is another example of the system 100 allowing a user to self-configure the system 100 to best serve a particular client of that user.

FIG. 8 shows a Task Templates screen 800, which is another maintenance area where the administrator doing the customizing for a particular office, client, or user can create add and delete desired tasks for different statuses as the property progresses thru the phases of management to sale and closing. For example, the tasks need to maintain a property having a “vacant” status (FIG. 8) is very different from what is needed for a property in a “pre-list” status (FIG. 8). Consequently, when a user becomes aware of a vacant property, that user can choose a “vacant” template. When a user becomes aware of a “pre-list” property, that user can choose a pre-list template.

Similarly, the tasks needed to maintain a property in Michigan are very different from the tasks needed to maintain a property in California. Any two states may have different legal procedures and requirements may for the different statuses of the properties, i.e. vacant, occupied, redemption, closed, pre-closed (FIG. 8). Thus, a template of tasks for a Michigan property will look very different from a template of tasks for a California property.

As shown in FIG. 8, the task, hdr, and list options 804 allow for editing the task lists and shows the task lists set up for each category. The designation “hdr” means a header record for a template, which is a brief description or name of a specific template. Editing task lists is useful because tasks needed for vacant redemption properties are significantly different than for occupied redemption. Similarly, tasks for prelist are different than for listed properties. When a property changes status from vacant to occupied, or prelist to listed, the tasks needed for that property will also change. All the different property statuses have different tasks needed, and the task, hdr, and list options 804 provide for setup and maintenance at an administrator level.

As shown in FIG. 9, the Company Resources screen 900 allows a user to upload and store blank forms that may be needed for each particular client (e.g. mortgage company). The Company Resources screen 900 allows users to access what paperwork a property manager would need to complete a task or assignment for each specific client. One example is the BPO or Broker Price Opinion form used for a first mortgage company (e.g. Homecomings, FIG. 9) properties, which might be different than the form used for a second mortgage company's (e.g. Countrywide) properties.

A specific client, bank, or other company's forms can be stored using the Resources screen 900 in a way that is conveniently accessible. The Resources screen 900 also can store the different company's requirements, policies, and procedures for reference, so that if there is a question as to a specific company/client's grass cut policy or automatic approved expenditure policy, it is possible to verify or confirm what those policies are.

FIG. 9 also shows some example uploaded forms that are used for client-specific requirements. For example, ASAM BPO is the form for ALL STAR ASSET MANAGEMENT assigned properties, where BPO stands for Broker Price Opinion, and HOA stands for Home Owner Association. Homeowner association forms are required on all “Homecomings” (a specific bank, lender, and client) properties which belong to a homeowners association. FIG. 9 is the section where client-required forms for reference or download to work on can be located.

The Documentation option shown at the left of FIGS. 4-9 can also be accessed from each particular property, and is where users can upload specific documents for a designated property. Examples can include but are not limited to the listing agreement any purchase agreements, all monthly reports completed, and all broker price opinions completed. The Documentation option can serve as a history of activity on the file and a single, unified place to go to for a particular property for review of any documents associated therewith.

The system 100 also includes a photo section within each property section (e.g. FIGS. 5A-C) so that photos can be uploaded for each specific property. This includes a primary photo that comes up with the property when its full page is displayed, but also additional photos including but not limited to damage photos, repair photos, trashout, personal property left behind, or other type of photo.

A Notes section will also appear within every specific property section (FIGS. 5A-C), so that notes regarding that property are readily available for review or reminder of something. Examples of notes include but are not limited to: no working septic on property; plumbing is missing, or mandatory septic or well inspection required per county.

The Quickview ID feature 404 (FIG. 4) takes advantage of the fact that every property is assigned an ID number within the system 100. By knowing a property's ID number, a user can type it in via the Quickview ID 404, and then go straight to that property. Many companies use some sort of numeric property ID system, thus the system 100 incorporates the Quickview feature 404 for quick access without necessitating forcing a user to go to the search boxes. One goal of the system 100 is simplicity and reducing complication where possible. Many users of the system 100 may not have sophisticated computer software experience. Thus, an unsophisticated computer user with only a vague, passing familiarity with computer software interfaces can still be shown how to enter a property ID and obtain results. Real estate offices sometimes employ personnel near to a minimum-wage level of skill, and often have turnover and new employees to show the system. It is thus desired to reduce training costs, and make a person as productive as early as possible in the training process. The Quickview feature 404 is one way to achieve this.

Customization of the system 100 is achieved at least through the task templates 800 and the HC groups 700, which allows each company that uses the system 100 to be able to customize to their specific needs for managing and selling properties. For example, a property located in Michigan may need snow removal tasks, but a property located in California may not. However, that California user may need year round pool maintenance. In either case, the system 100 enables adding and deleting items specific to a user and their required needs.

Example purchasers of the systems 100 could be real estate agents/companies which handle a large volume of REO or Real Estate Owned properties, which as stated within the lending industry is another term for foreclosed property. As stated, bank clients on more of a communication end where they can log in and view their properties and the activity on those properties. Examples of this would be the downloading and uploading of documents in the Documentation option (FIGS. 4-9) such as listing agreements or purchase agreements. The banks/clients could also have the ability to review the completed tasks of their properties.

The system 100 could also be used in regular retail, and non-foreclosure real estate asset management since it is customizable. Real estate companies not involved in foreclosure don't need to manage a lot of maintenance tasks but still have to track closings, offers, sign placement and lock boxes etc.

A client of a property manager can delegate their properties and larger volumes to sell and handle if the property manager can demonstrate the ability to do so. Having access to the management and tracking system 100 allows that user to effectively achieve this.

In regular real estate a listing agent can handle and manage more properties if he has the abilities to streamline his daily tasks needed. These tasks can include but are not limited to advertising, tracking calls, showing of properties, and client/customer communications. Accordingly, the system 100 can be used by both banks and everyday real estate companies choosing to work with an agent and company who has the ability to properly and efficiently manage their property from list to sale.

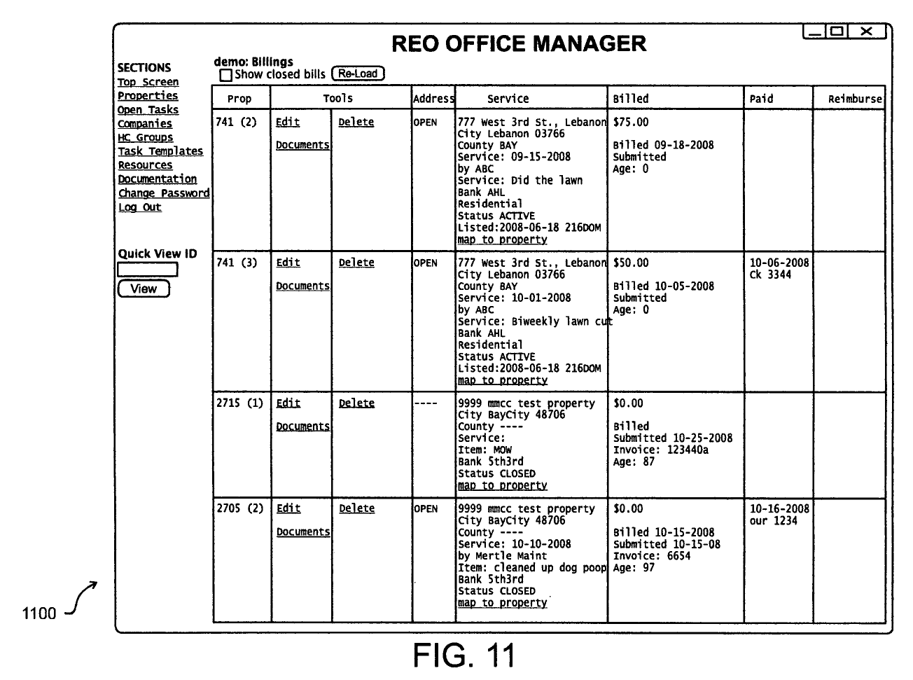

FIG. 11 depicts an example Billing screen 1100. A property manager may at times advance funds to vendors of property management services on behalf of a client (e.g. bank FIG. 1). The status of these invoices can be quickly discerned from a user interface such as the screen 1100 shown in FIG. 11. It is advantageous for the property manager to verify that the vendors have been paid, and if not paid, how long the invoice has sat unpaid. Although not shown in FIG. 11, it is also possible to determine whether the client has reimbursed the property manager or not, and if not how long since the property manager has been contacted.

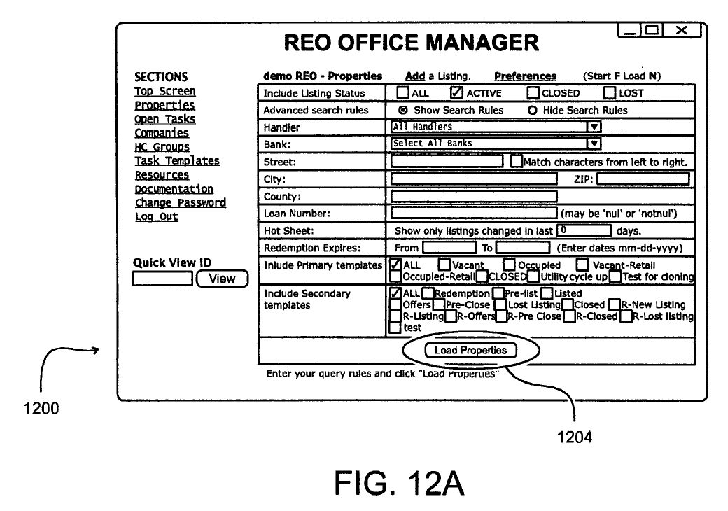

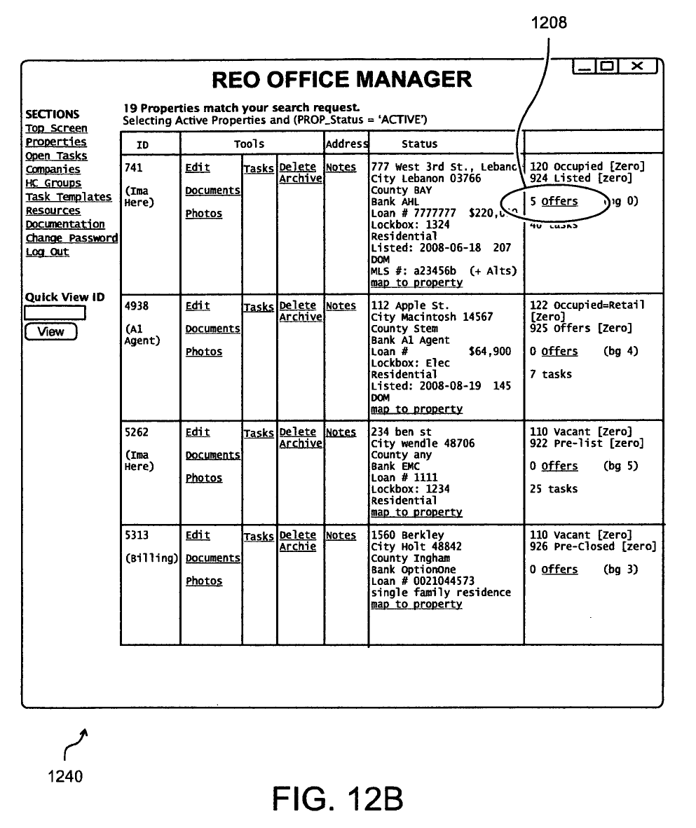

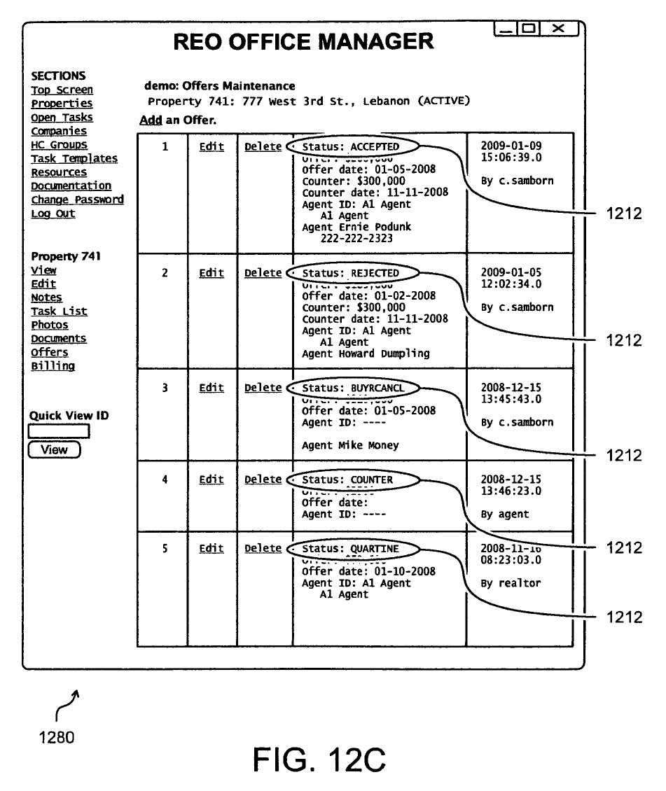

FIG. 12A depicts a refined version 1200 of the property search engine shown in FIG. 5C. Clicking on the “load properties” button 1204 takes a user to a screen similar to the screen 1240 shown in FIG. 12B, which depicts exemplary search results for a specific group of properties. From FIG. 12B it is apparent that one of the properties has 5 offers pending. By clicking on the “5 offers” link 1208, a user is then taken to a screen similar to the screen 1280 shown in FIG. 12C which depicts the status of all offers on a specific property. The system 100 contains safeguards to prevent an errant data-entry person from accidentally entering more than one offer as having an “accepted” status. Similar safeguards can be implemented for the various states of an offer (e.g. rejected, buyer canceled, counter-offer, and/or quartine, as well as potentially others.

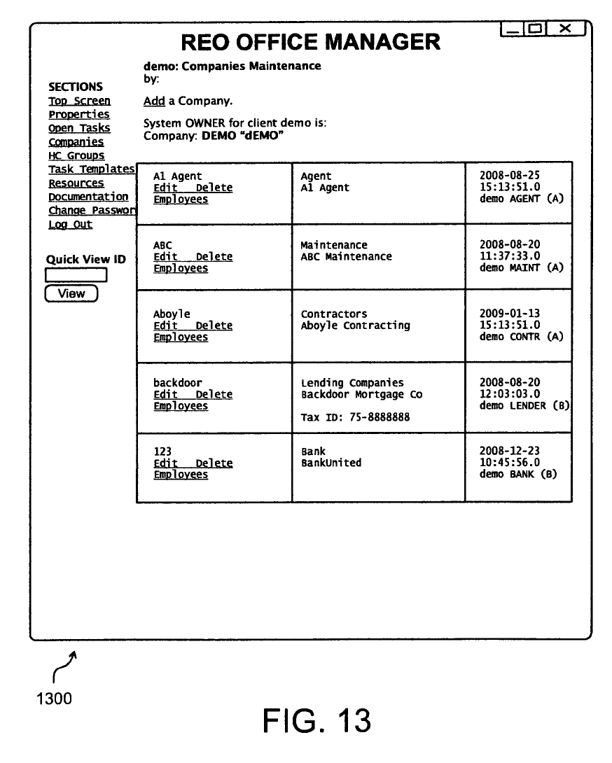

FIG. 13 shows a Companies screen 1300 for storing clients (e.g. banks) information. When adding a new client for the first time, info on a particular company or client is saved and them becomes a drop down menu to add to new property when that client gives a new assignment. Within the Companies section, a user can also input and then use a drop down of their employees that are assigned to the files. This helps monitor who the contact is on a particular property, and their contact info.

### Hardware Overview

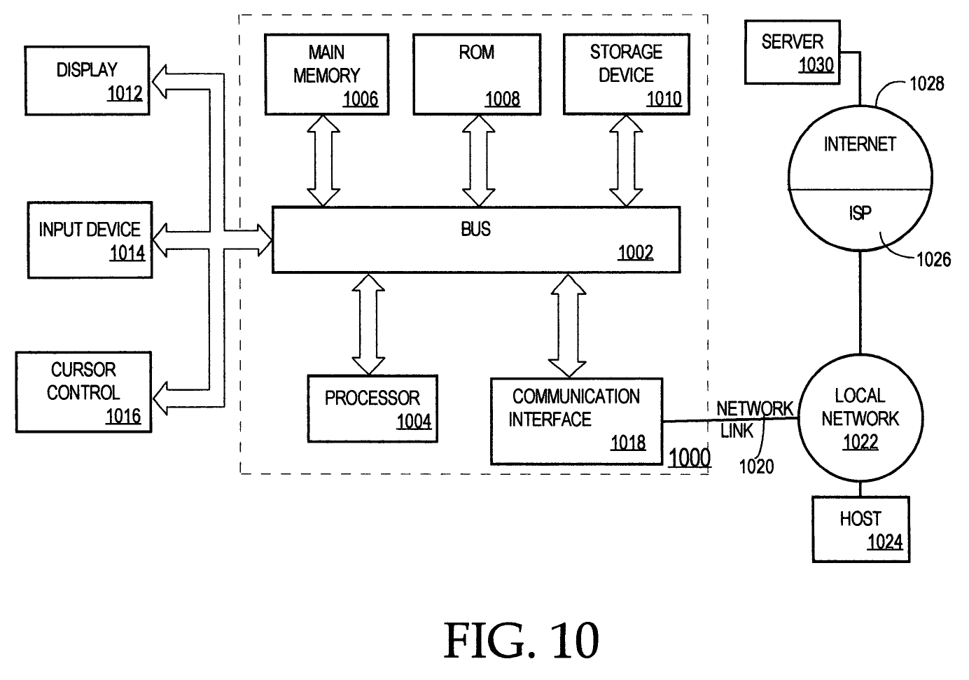

FIG. 10 is a block diagram that illustrates a computer system 1000 upon which an embodiment of the invention may be implemented. Computer system 1000 includes a bus 1002 or other communication mechanism for communicating information, and a processor 1004 coupled with bus 1002 for processing information. Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

The invention is related to the use of computer system 1000 for implementing the techniques described herein. According to one embodiment of the invention, those techniques are performed by computer system 1000 in response to processor 1004 executing one or more sequences of one or more instructions contained in main memory 1006. Such instructions may be read into main memory 1006 from another machine-readable medium, such as storage device 1010. Execution of the sequences of instructions contained in main memory 1006 causes processor 1004 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a machine to operation in a specific fashion. In an embodiment implemented using computer system 1000, various computer-readable media are involved, for example, in providing instructions to processor 1004 for execution. Such a medium may take many forms, including but not limited to storage media and transmission media. Storage media includes both non-volatile media and volatile media. Non-volatile media includes, for example, optical or magnetic disks, such as storage device 1010. Volatile media includes dynamic memory, such as main memory 1006. Transmission media includes coaxial cables, copper wire and fiber optics, including the wires that comprise bus 1002. Transmission media can also take the form of acoustic or light waves, such as those generated during radio-wave and infra-red data communications. All such media must be tangible to enable the instructions carried by the media to be detected by a physical mechanism that reads the instructions into a computer.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 1004 for execution. For example, the instructions may initially be carried on a magnetic disk of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are exemplary forms of carrier waves transporting the information.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising:
storing asset information related to a plurality of properties in a database, where the asset information is organized at least by a property identifier;
requesting the asset information from the database through a user interface having a plurality of user-selectable options, wherein said options comprise:
a properties option, which when selected expands into a panel displaying data associated with a plurality of properties organized by at least the following headings: property ID, tools, address, and active template;
an open tasks option, which when selected expands into a panel displaying at least the following for a specific property: a range of days of a plurality of tasks to be performed on the specific property, a task handler, a separate deadline for each of the plurality of tasks, a plurality of system-assigned section and step numbers, and a brief description of each specific task;
a companies option, which when selected expands into a panel displaying at least data about a company and allows a user to edit and delete the company data;
a maintenance group option, which when selected expands into a panel displaying at least data about a maintenance area where an administrator can setup and customize needed items when a specific property is first added to the database; and
a company resources option, which when selected expands into a panel displaying at least data allowing a user to upload and store blank forms that may be needed for one or more clients.

2. The method of claim 1, wherein the user interface is web-based and connected to a back-end database.

3. The method of claim 1, further comprising:
a back end database server separating, segregating, and securing the data of one or more clients.

4. The method of claim 3, wherein a first category of user is a client, and wherein the client is a bank.

5. The method of claim 4, wherein a second category of user is a property manager.

6. The method of claim 5, wherein the property manager has administrator capability.

7. The method of claim 1, wherein each of one or more clients has a separate logon through the front end logon screen

8. The method of claim 5, wherein the property manager has access to a task templates option, which when selected expands into a panel displaying at least information about adding and deleting tasks for different statuses as a specific property progresses thru the phases of management to sale and closing.

9. The method of claim 1, wherein a third category of user is a realtor, wherein the realtor either has an offer on a specific property or wishes to view the status of an existing offer.

10. The method of claim 1, further comprising:
a user requesting a display of the plurality of properties organized according to specific status of those properties.

11. The method of claim 1, further comprising:
a user searching the plurality of properties based on city, county, status, address, or client.

12. The method of claim 5, further comprising:
the open tasks menu depicting tasks related to tracking the progress of a specific property from beginning of delegation to a property manager all the way to sale and close of that property.

13. The method of claim 12, further comprising:
wherein one or more of the open tasks can be set to a recurring status, so that even when it is closed by a user, it is automatically reopened after a predetermined interval or predetermined event.

14. The method of claim 6, further comprising:
a maintenance area allowing the administrator to perform customizing for a particular office, client, user, or area where the system is being used can create add and delete desired tasks for different statuses of a specific property as that property progresses through management, sale, and closing.

15. The method of claim 1, further comprising:
a graphical user interface for assisting in uploading client-specific forms.

16. The method of claim 1, further comprising:
a photo section within each property listing so that photos can be uploaded for each specific property.

17. The method of claim 1, further comprising:
assigning a unique ID number to all properties;
a Quickview ID user interface allowing a user to enter the unique ID number and go straight to the listing for that specific property.

18. An apparatus, comprising:
one or more processors;
means, operatively coupled to the one or more processors, for storing information related to a plurality of properties in a database, where the information is organized at least by a property identifier;
means, operatively coupled to the one or more processors, for requesting the information from the database through a user interface having a plurality of user-selectable options, wherein said options comprise:
a properties option, which when selected expands into a panel displaying data associated with a plurality of properties organized by at least the following headings: property ID, tools, address, and active template;
an open tasks option, which when selected expands into a panel displaying at least the following for a specific property: a range of days of tasks to be displayed, a task handler, a separate deadline for each task that needs to be completed, a plurality of system-assigned section and step numbers, and a brief description of the specific task;
a companies option, which when selected expands into a panel displaying at least data about a company and allows a user to edit and delete the company data;
a maintenance group option, which when selected expands into a panel displaying at least data about a maintenance area where an administrator can setup and customize needed items when a specific property is first added to the database; and
a company resources option, which when selected expands into a panel displaying at least data allowing a user to upload and store blank forms that may be needed for one or more clients.

19. A graphical user interface for interacting with a web-enabled computer for managing assets, comprising:
a properties option, which when selected expands into a panel displaying data associated with a plurality of properties organized by at least the following headings: property ID, tools, address, and active template;
an open tasks option, which when selected expands into a panel displaying at least the following for a specific property: a range of days of tasks to be displayed, a task handler, a separate deadline for each task that needs to be completed, a plurality of system-assigned section and step numbers, and a brief description of the specific task;
a companies option, which when selected expands into a panel displaying at least data about a company and allows a user to edit and delete the company data;
a maintenance group option, which when selected expands into a panel displaying at least information about a maintenance area where an administrator can setup and customize needed items when a property is first added to a database; and
a company resources option, which when selected expands into a panel displaying at least data allowing a user to upload and store blank forms that may be needed for each of one or more clients.
